(19) United States
(12) Patent Application Publication
(10) Pub. No.: US 2012/0055836 A1
(43) Pub. Date: Mar. 8, 2012

(54) Process of making fuel resistant material and product made therefrom

(76) Inventors: Richard C. Andrews, (US); Jay Poole, (US); Shane Gregory, (US)

(21) Appl. No.: 12/923,188

(22) Filed: Sep. 8, 2010

(51) Int. Cl. B65D 85/00; B32B 37/10; B32B 37/14

(52) U.S. Cl. 206/524.6; 156/306.6; 156/184

(57) ABSTRACT

A method of manufacturing a fuel resistant material for use in collapsible fuel tanks that includes preparing a spreadable rubber mixture; spread coating the rubber mixture onto a fabric substrate; drying the rubber and fabric to create a primed fabric; applying a first rubber film on a first surface and a second rubber film on a second surface of the primed fabric, the first rubber film being applied at a thickness greater than a thickness on the second rubber film on the second surface to create an off balanced fabric; applying a third rubber film to the second surface to a produce a thickness substantially equal to that of the first surface to create a final coated product; and curing the final coated product.

### FIELD

This disclosure relates to fuel resistant materials devices and to methods for making fuel resistant materials, such as a rubberized material calendered onto a woven nylon fabric. More specifically, this disclosure relates to a method of making a fuel resistant material and a process of making such materials for use in collapsible fuel tanks.

### BACKGROUND

Collapsible fuel tanks or pillow tanks are bladder-type tanks that provide temporary and/or long term liquid storage for fuel and other liquids. Such tanks have a variety of uses including, for example, fuel storage in military operations, rescue operations, fuel transport, oil spill recovery operations, construction site support, bulk liquid transport, potable/grey water, storage of bilge liquid waste, or chemical storage. Pillow tanks may be designed for land based operations, but can be used on the decks of ocean going vessels, etc. Because pillow tanks are collapsible, they may be folded and stored when not in use.

Due to environmental condition and the types of materials being stored in pillow tanks, such tanks must be resistant to certain environmental factors including ultraviolet light, temperature variations, physical impacts and punctures. When used to store fuel, problems with existing collapsible pillow tanks have been noted including degradation of the materials from which the tanks are made. Due to material degradation, the integrity of the tanks may become compromised and leakage of fuel and/or tank failure may occur.

### SUMMARY

In an example embodiment of the claimed subject matter, a rubber collapsible pillow style tank for the storage and transport of most liquids may be realized through the use of materials manufactured as discussed herein. These fuel tanks may be made to military specifications to provide vital logistical support in military operations worldwide. Due to the characteristics imparted by the materials from which the containers are made, the containers may be deployed with a minimum of site preparation and may be used in single units or multi-tank form configurations.

When empty, the collapsible containers may be rolled and/or folded for convenient storage and transportation. The collapsible fuel tanks may be fabricated from a variety of polymer coated materials to meet specific operational requirements. In an example embodiment, the materials of construction depend on applications and may include a high tenacity, continuous filament nylon based fabric coated on the outside and inside of an underlying substrate with a range of materials such as nitrile, neoprene, PVC, and polyurethane.

Fabricators of collapsible fuel tanks may use the material manufactured by the claimed process to make “pillow tanks” in various sizes. The material is cut and placed into desired shapes and then heat-vulcanized seams are created to create a leak-proof collapsible fuel tank (i.e., pillow tank). Tanks manufactured from materials manufacture by the claimed process may safely and reliably hold diesel, aviation fuel, gasoline, JP-8 and JP-5, for example. The material made by the claimed process resists degradation and swelling when exposed to fuels to keep the tanks from leaking which can cause unsafe environmental and personal safety conditions. Additionally, fuel tank leaks may cause the loss of expensive fuels. In an example embodiment, the rubber compound on the material resists degradation when exposed to ozone, oxygen, humidity, rain water and all other environmental factors. The manufactured material is flexible so that empty tanks can be rolled up and stored for relocation and/or deployment at a later date.

In an example embodiment, the material is made by calendering a pre-mixed rubber formula onto two sides of a primed woven nylon or other acceptable fabric. One side of the calendered product is then “over-calendered” which creates two layers of rubber material on one side of the material. The material is then vulcanized using heat and pressure in order to impart the final physical properties. The material made by the claimed process significantly reduces the opportunity for leaks to occur in a collapsible fuel tank due to the two layers of specially formulated rubber compound on one side of the fabric. This material has a rubber formula compounded to resist degradation from exposure to environmental conditions, as well as degradation from exposure to the fuels mentioned above.

Advantages of these embodiments are set out hereafter, and further details and features of each of these embodiments are defined in the accompanying dependent claims and elsewhere in the following detailed description.

### BRIEF DESCRIPTION OF THE DRAWINGS

Various aspects of the teachings of the present disclosure, and arrangements embodying those teachings, will hereafter be described by way of illustrative example with reference to the accompanying drawings, in which:

FIG. 1 is a flow diagram of an example embodiment of a process of making the fuel resistant material;

FIG. 2 is a schematic diagram of an uncoated fabric being primed according to an example method;

FIG. 3 is a schematic diagram of a four roll calendering machine in an example method;

FIG. 4 is a cross-sectional view of a product produced by an example method after four roll calendering;

FIG. 5 is a schematic diagram of a three roll calendering machine according to an example method;

FIG. 6 is a cross-sectional view of a product produced by an example method after three roll calendering;

FIG. 7 is a schematic diagram of a wrapping process according to an example method; and

FIG. 8 is a schematic diagram of a curing process according to an example method.

### DETAILED DESCRIPTION OF EXAMPLE EMBODIMENTS

Example embodiments of the present disclosure will now be described with reference to an example method and process of making a fuel resistant material useful in collapsible pillow-type fuel tanks. It should be remembered, however, that the teachings of the present disclosure are not limited to only fuel resistant tanks but may be universally applicable to any type of collapsible pillow tank for storing liquids in severe conditions or for storing liquids that may cause degradation of known materials used in making pillow tanks.

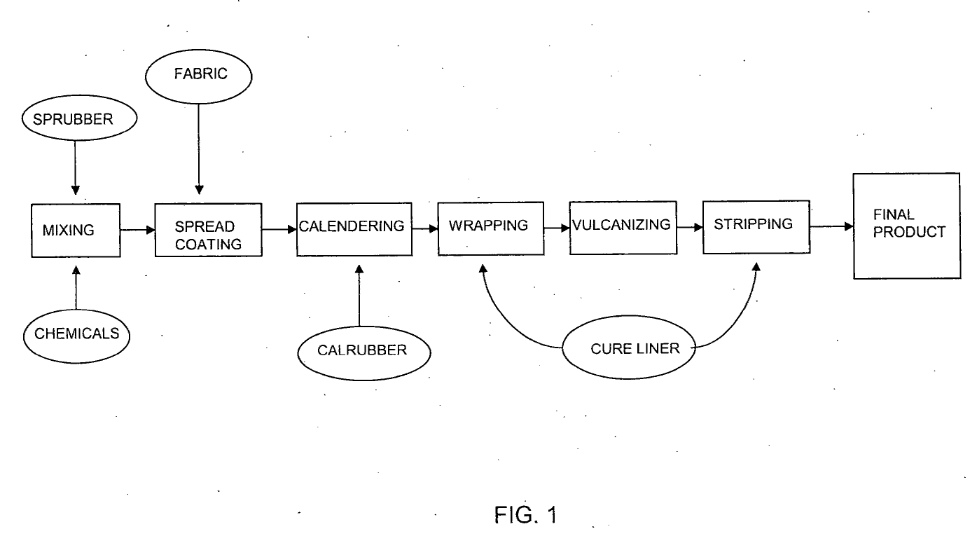

As shown in FIG. 1, the process of making the material begins with preparing a suitable blend of spread rubber (“sprubber”). The spread rubber may contain a blend of polymers, such as nitrile blends, neoprene, RFL (Resorcinol-Formaldehyde-Latex) coatings of nitrile or neoprene, or phenolics, for example; reinforcing fillers, such as carbon black, silica, or clay treated with silane, for example; and antioxidants/antiozidants (antidegradents), such as amines, phenolics, phosphites, hydroquinolines, hydroquinones, or toluimidazoles, for example. The spread rubber may also contain curitives. In the case of nitrile and nitrile/PVC blends the curative may be sulphur with sulfenimides and thiurams, for example. In the case of polychloroprene the curative may be sulphur with thioureas and benzothiozoles or thiourea with benzothiozole for example. In addition, the spread rubber may also contain plasticizers. In an example embodiment, the plasticizers are chosen for low-temperature flexibility and low extractability. For nitrile and blends, plasticizers such as phthalates, adipates, phosphates, polymerics, or formals may be used. For polychloroprenes, the same families are used. Other additives to the spread rubber may include, but are not limited to, release aids, pigments, and cure activators (such as stearic acid).

The components of the spread rubber mixture may be mixed on a mill or in an internal mixer. Mixing on a mill must break down (warm up) and band the polymer prior to adding other ingredients. Although the appropriate temperature and the amount of time on the mill vary in accordance with certain conditions such as the chosen type of mill or mixer, the selected polymer, etc., a temperature in a range of about 150° F. to about 200° F. with a mixing time of about 12 to 15 minutes is usually sufficient. Variations in milling temperature and time may also result from the type of mixer used. For an internal mixer, such as a Banbury or Shaw mixer, the temperature may preferably reach about 220° F. to 230° F. in about 8 to 12 minutes to properly break down and band the polymer. The addition of certain accelerators may be used in the compounding process before “slabbing off' the rubber after mixing.

During the mixing of the spread rubber components, temperatures should be maintained as low as possible to prevent premature initiation of the cure/scorching. For a spread rubber compound containing PVC, it is preferable that an adequate temperature is be reached and maintained in the mixing vessel. For example, a temperature of approximately 320° F. for a minimum of 2 minutes in order to flux the PVC may be preferable. The spread rubber blend is then provided in strips, slabs, or is pelletized after cooling. In an example embodiment, the rubber is cooled by hanging the strips on a rack or a conveyor with cool air blowing on them. The spread rubber also may be chopped into smaller pieces to later be put into solution. Spread rubber stored before or after being put into solution should be stored in a cool place to prevent scorch/partial-precuring of the compound.

In an example embodiment, the polymer used for the spread rubber may be NBR (nitrile butadiene copolymer) but is not limited to this. When preparing the spread rubber, the ACN (acrylonitrile) content of the polymer is chosen to provide low swell in the finished material due to the target fuel intended to be stored in the tank while maintaining flexibility at low temperatures. The chosen fillers may be of a laminar nature to enhance permeation resistance by being platy in nature and providing a longer effective path through the given thickness of rubber.

Subsequent to preparing the spread rubber mixture, other chemicals to be added to the spread rubber may be prepared in preparation of the spread coating step. In an example embodiment, such other chemicals may include adhesion promoters, such as isocyanate, resorcinol/hexamethoxymethyl-melamine, resorcinol/hexamethylenetetramine, phenolic resins, and RFL systems, for example. Such other chemicals may also include tackifyers, such as rosin esters and phenolics, added to the spread rubber at this step based on the type of substrate (fabric) to which the spread rubber mixture is to be applied. For example, the substrate may be nylon, polyester, or aramides, depending on the intended use of the finished material product.

In addition to the above described chemicals, a solvent blend, such as ketones (e.g., methyl ethyl ketone (MEK)) or blends of aromatics, such as toluene with the MEK may be chosen to dissolve the spread rubber and accompanying additives without undue toxicity or safety issues. The solvent which is later evaporated after dipping or spreading the fabric will leave a continuous film of polymer blend. In an example embodiment, in the case of nitrile adhesives for fuel resistance, methyl ethyl ketone is the solvent of choice.

During this mixing step, the spread rubber and the other chemicals are mixed together in a batch mixer as discussed above. In an example embodiment, pelletized spread rubber is mixed and put into solution in a churn or other mixer where the solvent, chemicals and the pelletized rubber are stirred until the rubber is solubilized. The temperature at which the components are processed and the required time may depend on the specifics of desired rubber compound and the chosen chemicals. However, in an example embodiment, mixing may occur for approximately three hours and at temperature kept below approximately 110° F. Mixing is complete when all of the rubber solids are dissolved into the solvents. The viscosity of the mixture and percent of solids are measured and used to determine the acceptability of the spread rubber used for coating the substrate fabric. In an example embodiment, the percent solids should be high enough to get approximately 0.001″ to 0.002″ onto the fabric with a viscosity that is low enough to gain some amount of penetration into the fabric.

Upon completion of this mixing step, the process proceeds to the spread coating step where the mixture is impregnated into a substrate, such as a fabric. The substrate or fabric is chosen with the end product determining the desired physical characteristics of the fabric. The end use of the finished product, such as in a fuel-type pillow tank, may determine the fabric construction to a great extent. For example, a tank that is enclosed in a metal enclosure, such as an aircraft wing tank, may not need as robust a construction as a tank that is not enclosed in a protective device, such as a pillow tank which is exposed to the elements.

In an example embodiment, the substrate fabric may be a woven or a knit with yarn denier in the warp and fill direction determined by the required physical characteristics of the finished tank. Such physical characteristics may include, but are not limited to, high tear or puncture resistance, and tensile strength based on the pressure of the contents. Example fabrics may include a yarn comprised of nylon, aramid (and the meta and para variants from various suppliers), polyester, cellulosics, glass, or metallic's. Various constructions for the choice of fabric may be used to gain desired strength, tensile properties, and tear properties. Yarns may be plied or used as a single end based on the physical requirements of the finished tank.

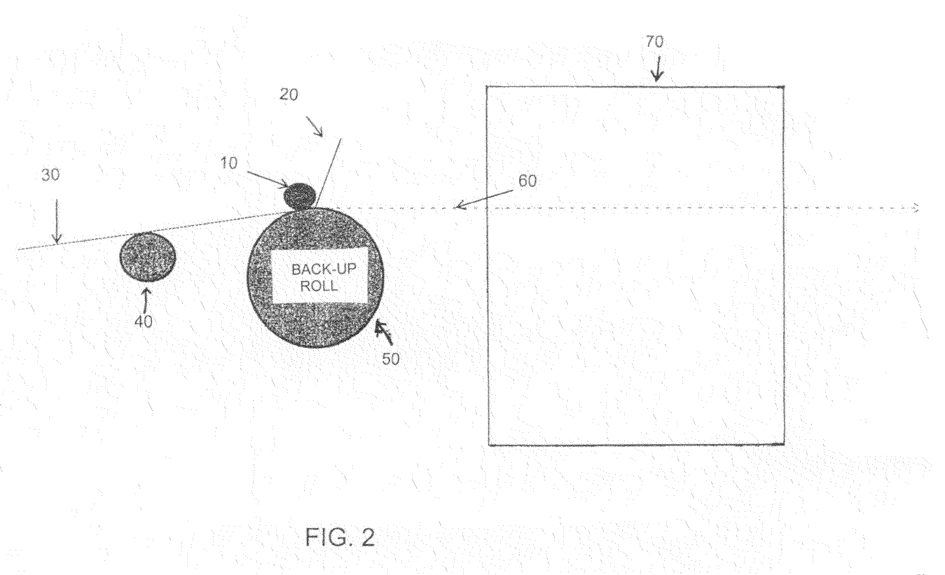

In the above described mixture, specified compounds have been put into solution to a specified amount of percent solids and compound to solvent ratio, for example, 15% to 40% solids. As shown in FIG. 2, during the spread coating step, the rubber solution mixture is loaded onto a spreader 20. The spreader 20 is set-up to a specific knife over roll gap setting (e.g., 0.003″-0.006″ above the surface of uncoated fabric 30) to apply an even coating of the mixture 10 onto the uncoated fabric 30. The uncoated fabric 30 is carried over a carrying roller 40 to pass between the knife edge of the spreader 20 and a back-up roll 50.

The uncoated fabric 30 is fed over the carrying roller 40 to the backup roll 50 under sufficient tension to present a smooth fabric under the knife at the spreader 20 and to allow for even coating of the uncoated fabric 30 with the rubber solution 10. In an example embodiment, the rubber solution 10 may be gravity feed or pumped onto the uncoated fabric 30 from a drum (not shown) and enters the knife 20 over the backup roll 50. The rubber solution 10 continues to be forced between the steel blade (knife) 20 on top of the fabric 30 and the backup roller 50 under the fabric 30 to deposit a desired specific amount of the rubber mixture 10 onto the fabric 30.

Upon being coated, the coated or primed fabric 60 is transported to an oven 70 which has temperatures in three oven zones to dry the primed fabric 60 which comprises the fabric substrate and the rubber mixture, as well as to remove any remaining solvent from the primed fabric 60. As the coated fabric 60 exits the knife and roll section, the fabric 60 goes directly into the oven 70 where the solvent is gradually removed by heat and forced air in the three controlled oven zones, as shown in FIG. 2, until all the solvent is removed and only the rubber remains on the fabric. In an example, embodiment, the oven zones may be 150° F. to 275° F. and may include air flow to remove evaporated solvent.

Although the time needed to remove the solvent as described is based on the length of the oven and the speed of the fabric 60 passing there through, in an example embodiment, approximately 20 yards of coated fabric 60 may be processed per minute. Once the fabric 30 has been spread primed, the coated fabric 60 is ready to have the rubber films applied in the calendaring step.

The rubber used on the calender may be comprised of polymer, fillers, plasticizers, antioxidants, antiozidants, pigments, process aids, and curatives as shown in Table 1 below.

| | Parts per hundred |
|---|---|
| Component | rubber |
| Nitrile polymer | 100 |
| Vinyl | 40-45 |
| Plasticizer | 25-60 |
| Filler | 30-50 |
| Silica | 30-50 |
| Black or pigments | 5-20 |
| Antioxidant antiozidant | 2-3 |
| Zinc oxide | 5 |
| Stearic acid | 1-1.5 |
| Process aids | 1 |
| Curatives | 3-5 |

In preparing the calendering rubber (“calrubber”) for the calendering step, it is preferable that particular attention be paid to the selection of the polymer or polymer blend. In the case of collapsible fuel tanks, the polymer of choice may preferably be NBR (acrylonitrile butadiene copolymer) and/or blends of fluxed NBR with PVC. In an example embodiment, the acrylonitrile (ACN) content of the rubber should be considered for the appropriate balance of fuel resistance and low temperature flexibility. A high ACN content level polymer (e.g., in the 35-41% level) offers excellent fuel resistance but may lack the desired low temperature properties to allow the pillow tank to flex without cracking. The proper plasticizer selection will help reach a desired balance of fuel resistance to temperature flexibility. It is preferable that the selected plasticizer not be extractable from the rubber layer when in contact with fuel. Also, the appropriate filler selection reinforces the polymer through physical and chemical interaction with the selected polymers and may be black, or silica in the case of colored tanks. In an example embodiment, a laminar filler may preferably aid in lowering fuel permeation by being platy in nature and providing a longer effective path through the given thickness of the rubber material on the fabric.

Antioxidants/antiozidants such as amines, phenolics, phosphates, hydroquinolines, hydroquinines and toluimidazoles, may provide protection from degradation in use or weathering due to temperature extremes and ultra-violet light, for example, and are an important part of the rubber compound to resist degradation. Selection of effective antidegradents may preferably include low solubility in the fuel expected to be used in a tank made from the material The selection of the appropriate package of curatives preferably provides the desired properties in the finished product while maintaining processing scorch safety (i.e., premature curing or of the components). Scorch in the polymer blend will not produce a smooth calendered sheet with good adhesion to the substrate and therefore is undesirable.

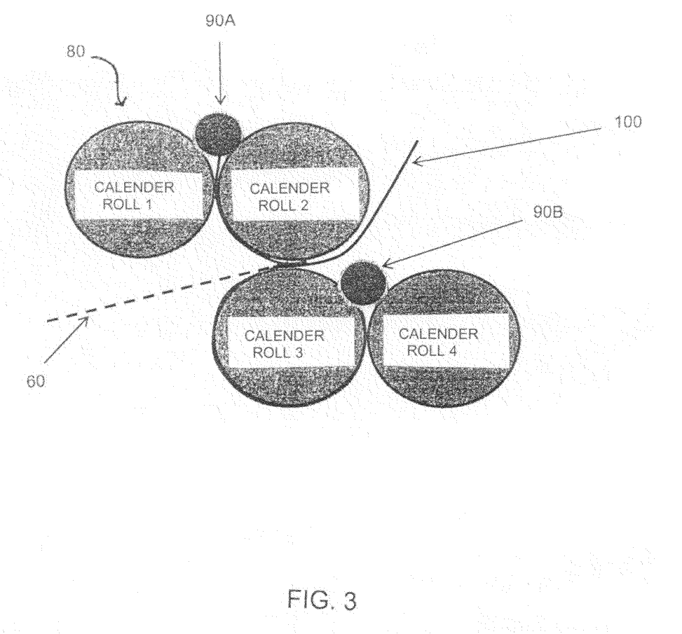

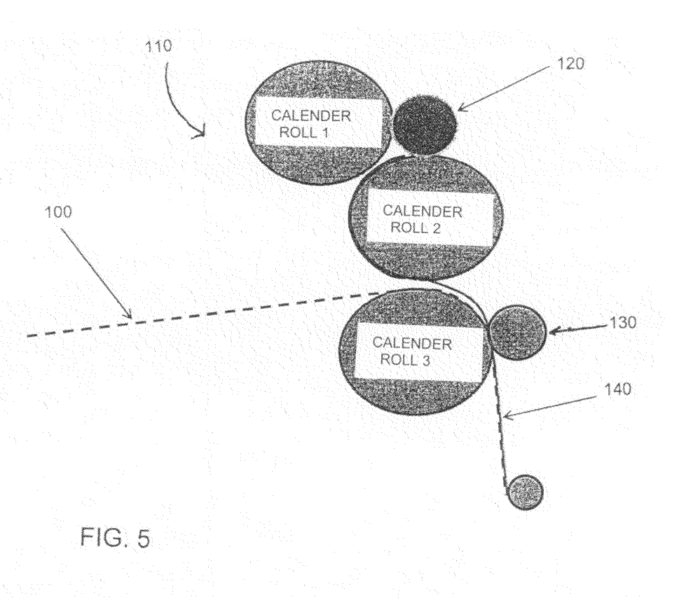

In the calendering steps, a four roll calender 80 capable of applying a rubber film (calendar rubber) 90 to both sides of the primed fabric 60 simultaneously may be employed (FIG. 3). This example method may also employ the use of a three roll calender 110 equipped with press on roller 130 to apply an over calender film 120 (FIG. 5).

As shown in FIG. 3, the primed fabric 60 is first threaded through the four roll machine 80. The calender rubber 90A, 90B to be applied to the primed fabric 60 is broken down (warmed up) by using a rubber mill, as described above, to soften rubber in slab form thereby lowering its viscosity and making the rubber more formable. The rubber may preferably be milled until the rubber becomes warm, soft and pliable at a temperature of about 150° F.-190° F. The calender rubber 90A is then fed by conveyor to the top side calender nip formed between calender roll 2 and the fabric 60 and the calender rubber 90B is fed to the bottom side calender nip formed between calender roll 3 and the fabric 60. In an example embodiment, the calender rolls 2, 3 are heated to a temperature between about 135° F. and 145° F. The rolls 2, 3 may be heated by hot oil, steam, or other methods.

Before the calender rubber 90A, 90B is applied to the primed fabric 60, the bottom calender nip is adjusted to a desired thickness and the top calender nip is adjusted to about half the thickness of the bottom film. In a non-limiting example embodiment, the bottom calender nip may be adjusted to about 0.0165″ (+/−0.001″) and the top calender nip is adjusted to a film thickness of about 0.008″ (+/−0.001″). Although the example embodiment describes the top calendar nip being adjusted to a gap less than the bottom calendar nip, the top gap may also be adjusted to a gap greater than a gap at the bottom nip.

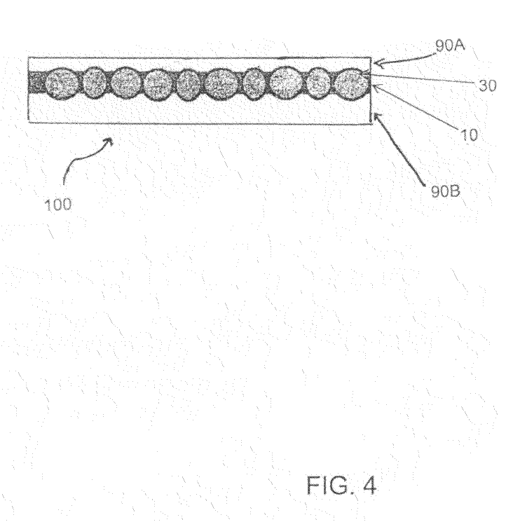

In an example embodiment, the calender rolls 2, 3 may “cross” over a horizontal axis parallel to that of a fixed roll (not shown) in order to compensate for roll deflection and to insure a flat sheet across its width. Once the desired film thicknesses have been achieved, the films are cut away from the corresponding calender rolls and placed over an idler (not shown) that will feed the films into their respective coating nips away from the surface of the roll itself to remove any trapped air. When the films 90A, 90B and the fabric 60 are in place, the calender rolls are set in motion and the gap closed so that the top and bottom films 90A, 90B are transferred to their respective surfaces of the primed fabric 60 to produce a double coated “off balanced” fabric 100 having one side thicker than the other. Yield from this process step is a calendered fabric that is off balanced with the finished coating being distributed at substantially 50%/25% (FIG. 4).

As shown in FIG. 4, the calendered product 100 produced by the four roll calender 80 includes a fabric 30 prime coated with the spread rubber 10 and having a top film of rubber 90A and a bottom film of rubber 90B that is relatively thicker than the top rubber film 90A. The balance 25% is preferably applied as an “over-calender film” in a subsequent calendaring step. Although the bottom layer shown in the example embodiment is relatively thicker than the top layer, the top layer may also be applied to be relatively thicker than the bottom layer.

Upon leaving the four roll calender machine 80, the double coated fabric 100 is transferred to the three roll calender machine 110. In the three roll calender machine 110, an over-calender film 120 is applied. The three roll calender machine 110 is equipped with a press on roll 130 and has the ability to apply a rubber film with zero tension on the film itself (FIG. 5). During this process, the double coated, off balanced fabric 100 is moved from the four roll machine 80 to the three roll machine 110 equipped with the press on roller 130. The calender film 120 in this step is only applied to the thinner coated side of fabric 100 (i.e., the side that has 25% of total film distribution). As shown in FIG. 5, the off balanced calendered fabric 100 is first threaded through the three roll machine 110. In an example embodiment, the calender rubber 120 to be used for the film is broken down (warmed up) by using a rubber mill, and/or extruder as described above. The rubber is milled/extruded until it becomes warm, soft and pliable at approximately 150° F.-190° F.

Once the rubber is properly warmed, the rubber 120 is then fed by conveyor to the calender nip between the press roller 130 and calender roll 3 of the three roll machine 110. As above, it is preferable that the calender rolls 2, 3 be heated to between 135° F. and 145° F. In an example embodiment, the calender film thickness is set to “balance” the amount of calendered rubber on the two sides of the fabric 100. In an example embodiment, the calendar film thickness is set to approximately 0.008″. The adjusting calender roll 3 “crosses” over the horizontal axis parallel to that of the fixed roll (not shown) in order to compensate for roll deflection and create a flat sheet across its width. Once the desired film thickness has been achieved, the film is cut away from the calender roll and fed over an idler (not shown) that creates a path for the film into the nip away from the surface of the calender roll itself to remove any trapped air.

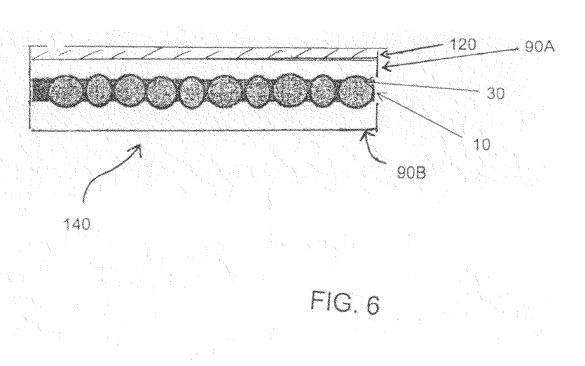

When the film 120 and fabric 100 are in place the fabric 100 passes through the calender underneath the 0.008″ film, the film is cut away from the face of the calender roll and fed into the gap created by the calender roll 3 and the press roll 130. In an example embodiment, there is substantially no tension on the additional film itself and the film is pressed onto the previously calendered film side to create a thicker coating film more closely equating to the thicker coating applied by the four roll machine 80 (FIG. 6). In an example embodiment, the two films may each be approximately 0.008″ at exiting the three roll calendering machine 110. The additional film 120 is applied substantially smoothly, without tension, without distortion and free of trapped air that once cured creates a “barrier” that liquid fuels cannot penetrate.

As shown in FIG. 6, the calendered product 140 produced by the three roll calender 110 includes a fabric 30 prime coated with the spread rubber 10 and having a top film of rubber 90A and a bottom film of rubber 90B that is relatively thicker than the top rubber film 90A. An added film of rubber 120 has been applied to the top film of rubber 90A as an “over-calender film”. Although over-calender film has been added to the top layer 90A, an over-calender film 120 may be added to a relatively thinner bottom layer.

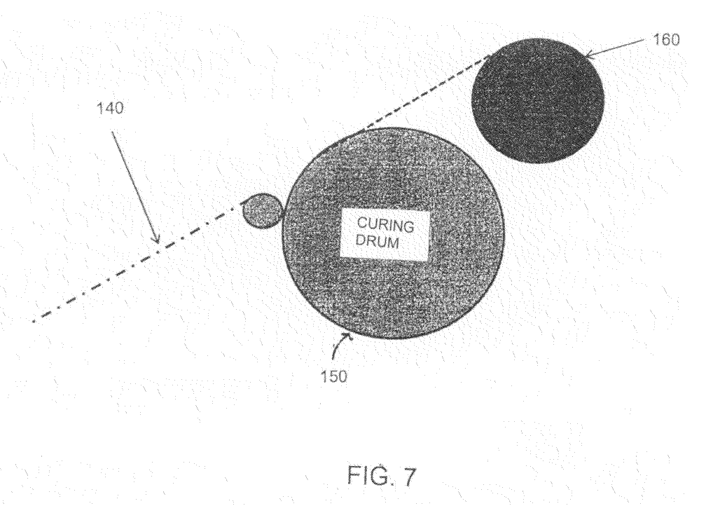

Upon completion of the calendering steps, the process proceeds to a wrapping step (FIG. 7). During wrapping, the final coated fabric 140 from the calendering process is wrapped onto a large steel drum 150 with a cure liner 160 being interleaved between the wrapped layers of the coated fabric 140. In an example embodiment, the cure liner 160 may be a 4.4 oz. siloxane treated 250 denier flat polyester warp, 2/150 denier text polyester fill, plain weave, scoured and heat set.

During wrapping, the tension of the rubber coated fabric 140 and the tension of the cure liner 160 while they are being wrapped onto the drum 150 are monitored to ensure that the materials are wrapped straight so that the wraps build up evenly on the drum 150. An additional heavy-weight fabric (not shown) is used to overwrap the entire drum 150 after the product 140 and cure liner 160 are wrapped.

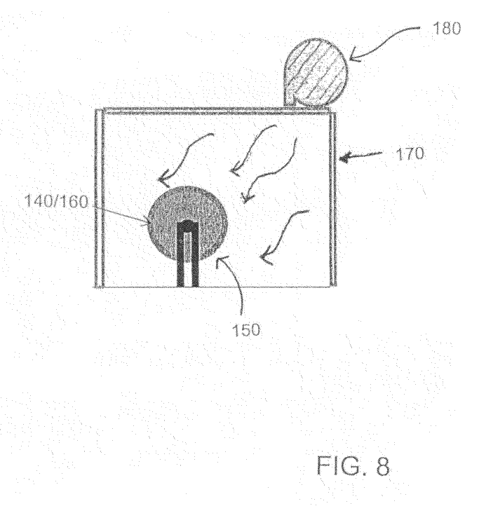

Upon completion of the wrapping process, a vulcanizing or curing process is commenced whereby the drums 150 from the wrapping process step are placed inside a large, hot air oven 170 (FIG. 8). In an example embodiment, the oven 170 is heated from room temperature to about 230° F. over a 30 minute period at a rate of about 5° F. per minute. The oven temperature is then maintained at substantially 230° F. for approximately 4 hours. The oven 170 is then further heated to approximately 300° F. and held at that temperature for about 13 hours to cure/vulcanize the product. The oven 170 may include a blower 180 to aid in the process. At the end of the cure cycle, the oven 170 is turned off and the drums 150 with the cured product 140 are removed.

After the drums 150 are removed from the oven 170 (i.e., the vulcanizing vessel) the drums 150 are left in the open air to cool for a minimum of about 12 hours. After cooling, the heavy weight fabric overwrap is removed from the drums 150 and the product 140 and the cure liner 160 are stripped off the drum 150. The cure liner 160 is re-wound onto a dowel (not shown) and set aside to be reused. The finished product is wrapped onto a different dowel and is inspected and put into finished goods inventory awaiting shipment to customer.

It will also be appreciated that while various aspects and embodiments of the present disclosure have heretofore been described, the scope of the present disclosure is not limited to the particular arrangements set out herein and instead extends to encompass all arrangements, and modifications and alterations thereto, which fall within the scope of the appended claims.

Lastly, it should also be noted that whilst the accompanying claims set out particular combinations of features described herein, the scope of the present disclosure is not limited to the particular combinations hereafter claimed, but instead extends to encompass any combination of features or embodiments herein disclosed irrespective of whether or not that particular combination has been specifically enumerated in the accompanying claims at this time.

1. A method for making a fuel resistant material for use in constructing collapsible tanks, the method comprising:
preparing a spreadable rubber mixture;
spread coating the rubber mixture onto a substrate;
drying the rubber and the substrate to create a primed substrate;
applying a first rubber film on a first surface of the primed substrate and a second rubber film on a second surface of the primed substrate, the first rubber film being applied at a thickness greater than a thickness of the second rubber film on the second surface to create an off balanced substrate;
applying a third rubber film to the second surface to a produce a thickness substantially equal to that of the first surface to create a final coated product; and
curing the final coated product.

2. The method of claim 1, wherein preparing the spreadable rubber mixture includes mixing a blend of polymers, reinforcing fibers and antidegradant compounds in a mixing device and heating the mixture at a temperature sufficient to mix the blend and cooling the rubber mixture.

3. The method of claim 2, wherein preparing the spreadable rubber mixture further includes mixing a plasticizer in the blend to provide low temperature flexibility to the final coated product.

4. The method of claim 1, further comprising mixing additional chemicals with the spreadable rubber mixture in the mixing device, the chemicals including at least one of an adhesion promoter, a tackifyer and a solvent.

5. The method of claim 1, wherein spread coating the rubber mixture includes loading the rubber mixture in a spreader and applying the rubber mixture in an even coating onto the substrate.

6. The method of claim 5, wherein spread coating the rubber mixture further includes transporting the substrate between the spreader and a roller, wherein the spreader is set to a knife edge providing a desired gap between the spreader and the roll to spread a desired coating of the rubber mixture on the substrate.

7. The method of claim 6, further comprising transporting the coated substrate to a drying device and drying the applied rubber mixture and substrate to create the primed substrate.

8. The method of claim 6, further comprising:
transporting the primed substrate to a first pair of opposed rollers, wherein the first rubber film is applied to the first surface at a nip between the first pair of opposed rollers and the second rubber film is applied to the second surface at the nip between the first pair of opposed rollers to create the off balanced substrate.

9. The method of claim 1, wherein the thickness of the thickness of the second rubber film on the second surface is approximately the one half the thickness of the first rubber film on the first surface.

10. The method of claim 1 further comprising, transporting the off balanced substrate to a second pair of opposed rollers, wherein the third rubber film is applied to the second surface at a nip between the second pair of opposed rollers.

11. The method of claim 9, wherein the third rubber film is applied with substantially no tension on the third rubber film.

12. The method of claim 1, further comprising wrapping the final coated product onto a drum and curing the final coated product.

13. The method of claim 12, further comprising interleaving a cure liner between wraps of the final coated product on the drum prior to curing.

14. The method of claim 12, wherein curing the final coated product includes:
heating the final coated product in a curing device from a first temperature of about 68° F. to a second temperature of about 230° F.,
holding the final coated product at the second temperature for a first period of time,
increasing the temperature to a third temperature higher than the second temperature, and
holding the final coated product at the third temperature for a second period of time longer than the first period of time.

15. A fuel resistant material for use in collapsible tanks, comprising:
a substrate having a primer coat impregnated thereon;
a first rubber film layer of a first thickness applied on a first side of the substrate;
a second rubber film of a second thickness applied on a second side of the substrate, the second rubber film being thinner than the first rubber film; and
a third rubber film over laid on the second rubber film, the second rubber film having thickness approximately equal to a difference in thickness between the first rubber film and the second rubber film.

16. A fuel resistant material for use in collapsible tanks resulting from a process comprising:
preparing a spreadable rubber mixture;
spread coating the rubber mixture onto a substrate;
drying the rubber and the substrate to create a primed substrate;
applying a first rubber film on a first surface of the primed substrate and a second rubber film on a second surface of the primed substrate, the first rubber film being applied at a thickness greater than a thickness of the second rubber film on the second surface to create an off balanced substrate;
applying a third rubber film to the second surface to a produce a thickness substantially equal to that of the first surface to create a final coated product; and
curing the final coated product.
